(19) United States
(12) Patent Application Publication
(10) Pub. No.: US 2022/0327248 A1
(43) Pub. Date: Oct. 13, 2022

(54) ELECTRONIC APPARATUS

(71) Applicant: KYOCERA Document Solutions Inc., Osaka (JP)

(72) Inventor: Isao Koda, Osaka (JP)

(21) Appl. No.: 17/714,858

(22) Filed: Apr. 6, 2022

(30) Foreign Application Priority Data
Apr. 8, 2021 (JP) 2021-065618

(51) Int. Cl. G06F 21/84; G06F 21/31; G06V 40/16

(52) U.S. Cl. CPC G06F 21/84; G06F 21/31; G06V 40/164

(57) ABSTRACT

An electronic apparatus includes a user interface unit and a user authentication unit. The user interface unit displays on a display device a user authentication screen that includes an input field for a password, and determines an inputted character string to the input field by a user operation performed to an input device. The user authentication unit performs user authentication on the basis of the inputted character string and a preregistered password. The user interface unit (a) determines a sight direction of the user on the basis of a face image taken by an imaging device, (b) determines whether the sight direction points to a predetermined range that includes the input field, and (c) if the sight direction points to the predetermined range, displays the inputted character string in the input field, or if not, displays a mask character string in the input field.

### CROSS-REFERENCE TO RELATED APPLICATIONS

This application relates to and claims priority rights from Japanese Patent Application No. 2021-065618, filed on Apr. 8, 2021, the entire disclosures of which are hereby incorporated by reference herein.

### BACKGROUND

### 1. Field of the Present Disclosure

The present disclosure relates to an electronic apparatus.

### 2. Description of the Related Art

An electronic apparatus detects input of a user name and a password as user identification information for user authentication, and determines whether an inputted character string of the password should be displayed or not in accordance with a setting value of a display mode.

In the aforementioned electronic apparatus, a user appropriately edits the setting value of the display mode and thereby can select whether an inputted character string of the password is displayed or not on the electronic apparatus. However, if such inputted character string of the password is always displayed on the electronic apparatus, a third person may steal a glance at the password. On the other hand, if such inputted character string of the password is always undisplayed on the electronic apparatus, a user can not input a remaining part of the password while visually confirming an inputted part of the password, and therefore, mistype easily occurs of the password.

### SUMMARY

An electronic apparatus according to an aspect of the present disclosure includes a user interface unit, a user authentication unit, and an imaging device. The user interface unit is configured to display on a predetermined display device a user authentication screen that includes an input field for a password, and determine an inputted character string to the input field by a user operation performed to a predetermined input device. The user authentication unit is configured to perform user authentication on the basis of the inputted character string and a preregistered password. The user interface unit displays the inputted character string or a predetermined mask character string in the input field. Further, the user interface unit (a) determines a sight direction of the user on the basis of a face image taken by the imaging device, (b) determines whether or not the sight direction points to a predetermined range that includes the input field, and (c) if the sight direction points to the predetermined range, displays the inputted character string in the input field or if the sight direction does not point to the predetermined range, displays the mask character string in the input field.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image forming apparatus as an example of an electronic apparatus according to an embodiment of the present disclosure;

FIG. 2 shows a front view of the operation panel 11 in FIG. 1; and

FIG. 3 shows a flowchart that explains a behavior of the image forming apparatus shown in FIG. 1.

### DETAILED DESCRIPTION

Hereinafter, an embodiment according to an aspect of the present disclosure will be explained with reference to drawings.

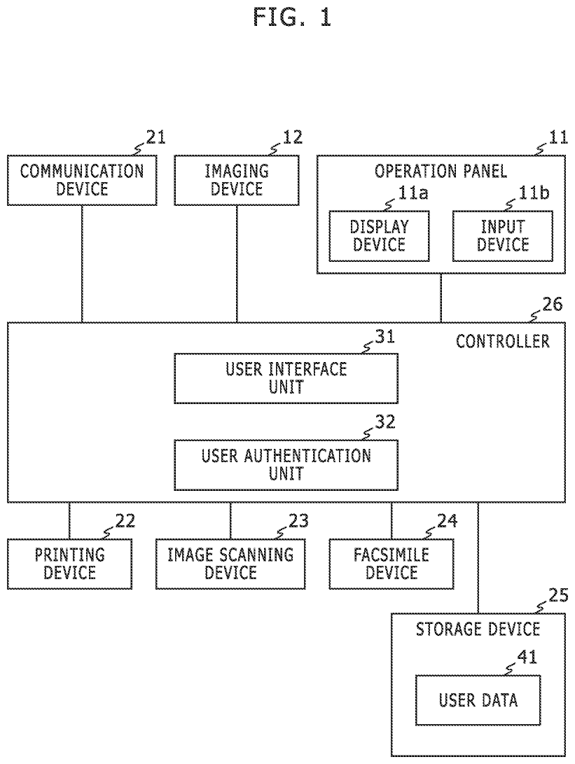

FIG. 1 shows a block diagram that indicates a configuration of an image forming apparatus as an example of an electronic apparatus according to an embodiment of the present disclosure. The image forming apparatus shown in FIG. 1 is a multi function peripheral that has a printing function, an image scanning function, and a facsimile function. This image forming apparatus includes an operation panel 11, an imaging device 12, a communication device 21, a printing device 22, an image scanning device 23, a facsimile device 24, a storage device 25, and a controller 26.

The operation panel 11 includes a display device 11a such as a liquid crystal display and an input device 11b such as a touch panel, and thereby displays an operation screen for a user and detects a user operation. The display device 11a displays an operations screen to a user and the input device 11b receives a user operation inputted by the user.

The imaging device 12 is arranged on the operation panel 11 or a housing of this image forming apparatus such that an angle of view of this imaging device 12 includes a face of a user of this image forming apparatus (i.e. a user who is operating the operation panel 11 of this image forming apparatus).

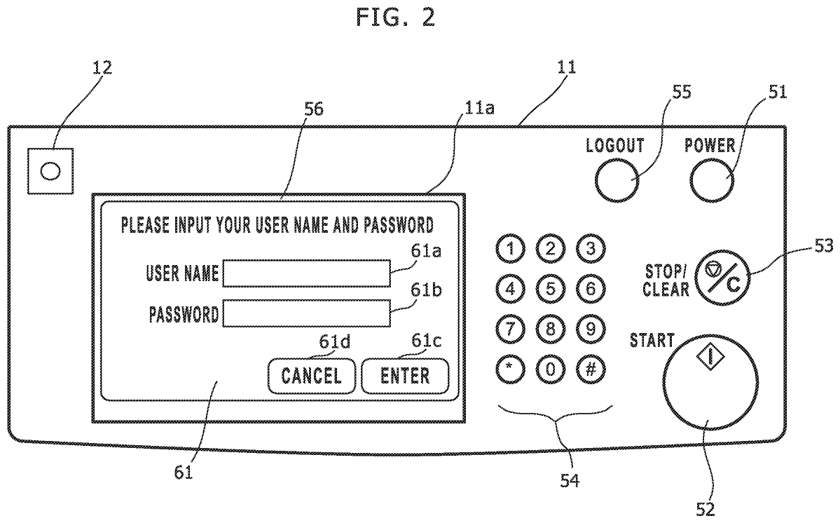

FIG. 2 shows a front view of the operation panel 11 in FIG. 1. The operation panel 11 shown in FIG. 2 includes hard keys 51 to 55 and a touch panel 56 as the input device 11b. The hard key 51 is a POWER key, the hard key 52 is a START key, the hard key 53 is a STOP/CLEAR key, the hard keys 54 are numeric keys, and the hard key 55 is a LOGOUT key. The touch panel 56 is arranged on a surface of the display device 11a.

Further, the communication device 21 is a device capable of connecting through a network or the like to an unshown host device and performing data communication in accordance with a predetermined communication protocol.

Furthermore, the printing device 22 is an internal device that prints a document image on a printing paper sheet, for example, in an electrophotographic manner. The image scanning device 23 is an internal device that optically scans a document image from a document, and generates image data of the document image. The facsimile device 24 is an internal device that has a receiving function that receives a facsimile signal and converts the facsimile signal to image data and a transmitting function that converts image data to a facsimile signal and transmits the facsimile signal.

Furthermore, the storage device 25 is a non volatile storage device such as a hard disk drive or a flash memory, and stores data, a program and the like. In the storage device 25, user data 41 is stored. The user data 41 includes a valid pair of a user name (user ID) and a password corresponding to each registered user.

Furthermore, the controller 26 includes a computer that includes a CPU (Central Processing Unit), a ROM (Read Only Memory), a RAM (Random Access Memory) and the like (not shown), loads a program stored in the ROM or the storage device 25 to the RAM, executes the program with the CPU, and thereby acts as various processing units.

In this embodiment, the controller 26 acts as a user interface unit 31 and a user authentication unit 32.

The user interface unit 31 causes the display device 11a of the operation panel 11 to display a screen and causes the display device 11a to change a screen to be displayed by the display device 11a in accordance with an input operation detected by the input device 11b of the operation panel 11.

Further, the user interface unit 31 displays a user authentication screen 61 as shown in FIG. 2 on a predetermined display device (here, the display device 11a). The user authentication screen 61 includes an input field 61a for a user name, an input field 61b for a password, an ENTER key 61c as a soft key, and a CANCEL key 61d as a soft key.

Furthermore, the user interface unit 31 determines an inputted character string to the input field 61a or 61b, which was inputted by a user operation to the input device 11b.

Furthermore, the user interface unit 31 detects a user operation to an operation part for fixing a character string inputted to the input field 61a or 61b by a user. In this embodiment, as this operation part, the ENTER key 61c as a soft key is used, and the touch panel 56 detects a user operation to the ENTER key 61c. As this operation part, a predetermined hard key may be used.

Furthermore, regarding the input field 61b for a password, the user interface unit 31 displays either the inputted character string or a predetermined mask character string in the input field 61b.

Specifically, the user authentication unit 31 (a) determines a sight direction of the user on the basis of a face image of the user taken by the imaging device 12; (b) determines whether or not the sight direction points to a predetermined range that includes the input field 61b; and (c) if the sight direction points to the predetermined range, displays the inputted character string in the input field 61b or if the sight direction does not point to the predetermined range (here, a case that the sight direction does not point to the predetermined range includes a case that the sight direction is not detected), displays the mask character string in the input field 61b.

Here, the mask character string is a character string of which the number of character(s) is the same as the number of character(s) of the inputted character string, and consists of one or more characters of a fixed character type (e.g. “*”).

Further, the aforementioned predetermined range is set as either the input field 61b only or an operation screen that includes the input field 61b (here, the user authentication screen 61).

In this embodiment, repeatedly until the user authentication is succeeded, the user interface unit 31 performs (a) the determination of a current sight direction of the user, (b) the determination of whether or not the current sight direction points to the predetermined range, and (c) displaying the inputted character string or the mask character sting in the input field 61b in accordance with a result of the determination.

The user interface unit 31 determines a face image in a taken image based on the aforementioned image data in accordance with an existent image recognition technique, determines an eye image in the face image, and determines a sight direction of the user on the basis of the eye image.

Further, in this embodiment, the user interface unit 31 (a) determines as a reference direction a sight direction of the user on the basis of a face image of the user taken by the imaging device 12 when a key operation occurs to a predetermined key as a reference point and associates and stores the reference point and the reference direction with each other in the RAM or the like, and (b) determines whether the current sight direction points to the predetermined range or not on the basis of the reference point and the reference direction (and the sight direction when inputting the password).

This predetermined key may be any one of the aforementioned keys, and may be a soft key or a hard key, and this predetermined key is a key operated before inputting the password when the user uses this image forming apparatus.

Further, if in the aforementioned user authentication the user authentication unit 32 determines that the user authentication is failed because a character string inputted to the input field 61b is not a valid password, then the user interface unit 31, for example, clears the character string inputted to the input field 61b and continues to display the aforementioned user authentication screen 61.

When a user operation to the aforementioned operation part was detected (here, when the touch panel 56 detected pushing down the ENTER key 61c), the user authentication unit 32 performs the user authentication based on the character strings inputted to the input fields 61a and 61b and a preregistered password. The user authentication unit 32 may perform the user authentication using an authentication server that manages user data that is the same as the user data 41.

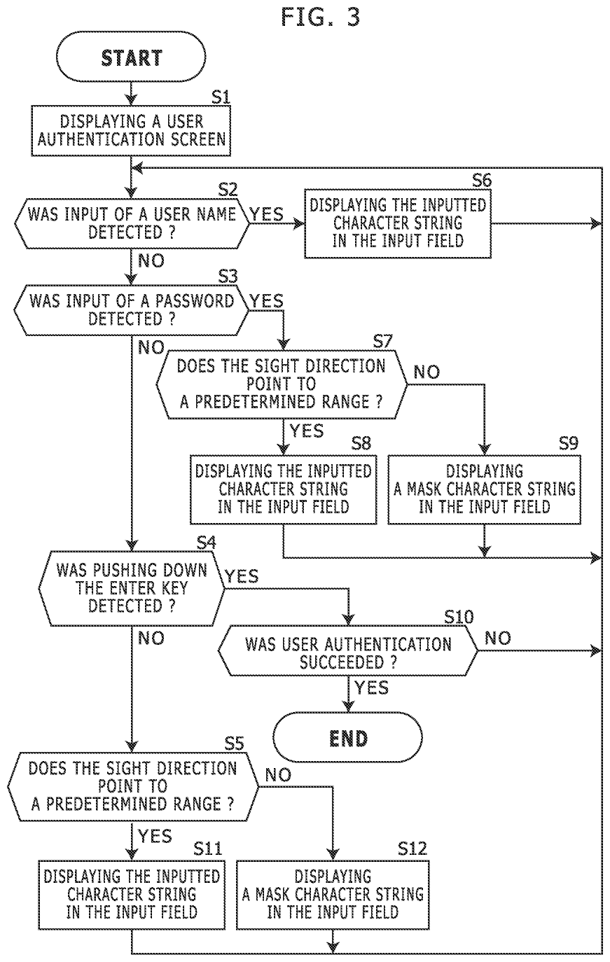

The following part explains a behavior of the aforementioned image forming apparatus. FIG. 3 shows a flowchart that explains a behavior of the image forming apparatus shown in FIG. 1.

When this image forming apparatus starts, for example, the user interface unit 31 displays the user authentication screen 61 on the display device 11a (in Step S1), and afterward repeatedly determines whether input of a character (as a part of a user name) to the input field 61a was detected or not (in Step S2), whether input of a character (as a part of a password) to the input field 61b was detected or not (in Step S3), whether pushing down the ENTER key 61c was detected or not (in Step S4), and whether a current sight direction of a user points to the predetermined range or not (in Step S5).

If character input to the input field 61a was detected, then the user interface unit 31 displays in the input field 61a an inputted character string that consists of one or more inputted characters that has/have been inputted to the input field 61a (in Step S6).

If character input to the input field 61b was detected, then the user interface unit 31 displays in the input field 61b either the mask character string or an inputted character string that consists of one or more inputted characters that has/have been inputted to the input field 61b.

In this process, the user interface unit 31 determines whether a sight direction of the user points to the predetermined range or not (in Step S7); and if the sight direction of the user points to the predetermined range, then the user interface unit 31 displays in the input field 61b the inputted character string that consists of one or more inputted characters that has/have been inputted to the input field 61b (in Step S8), and otherwise if not, then the user interface unit 31 displays the mask character string in the input field 61b (in Step S9).

Further, if pushing down the ENTER key 61c was detected, then the user authentication unit 32 performs the user authentication based on a character string inputted to the input field 61a until now and a character string inputted to the input field 61b until now; and if the user authentication was succeeded, then the user authentication unit 32 terminates this process (in Step S10), and for example, thereby the user is allowed to use this image forming apparatus.

Furthermore, the user interface unit 31 watches a current sight direction of the user even in a period that the user does not perform the character input of the password; and if the user's sight direction points to the aforementioned range, the user interface unit 31 changes a character string displayed in the input field 61b to the inputted character string (in Step S11), and if the user's sight direction does not point to the aforementioned range, the user interface unit 31 changes a character string displayed in the input field 61b to the mask character string (in Step S12).

As mentioned, in the aforementioned embodiment, the user interface unit 31 displays on the display device 11a a user authentication screen that includes an input field 61b for a password, and the user authentication unit 32 performs user authentication on the basis of a preregistered password and an inputted character string to the input field by a user operation performed to a predetermined input device 11b. Further, the user interface unit 31 (a) determines a sight direction of the user on the basis of a face image taken by the imaging device 12, (b) determines whether or not the sight direction points to a predetermined range that includes the input field 61b, and (c) if the sight direction points to the predetermined range, displays the inputted character string in the input field 61b or if the sight direction does not point to the predetermined range, displays the mask character string in the input field 61b.

Consequently, while the user is inputting a password, a part of the password that has been inputted is displayed, and if the user stops inputting the password in the middle, then the part of the password that has been inputted is hidden, and thereby restrained are both mistype of the password and visual leakage of the password to a third person.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the image forming apparatus is shown as an example of the aforementioned electronic apparatus. Alternatively, the aforementioned electronic apparatus may be another type of an electronic apparatus than the image forming apparatus.

What is claimed is:

1. An electronic apparatus, comprising:
a user interface unit configured to display on a predetermined display device a user authentication screen that includes an input field for a password, and determine an inputted character string to the input field by a user operation performed to a predetermined input device;
a user authentication unit configured to perform user authentication on the basis of the inputted character string and a preregistered password; and
an imaging device;
wherein the user interface unit displays the inputted character string or a predetermined mask character string in the input field; and
the user interface unit (a) determines a sight direction of the user on the basis of a face image taken by the imaging device, (b) determines whether or not the sight direction points to a predetermined range that includes the input field, and (c) if the sight direction points to the predetermined range, displays the inputted character string in the input field or if the sight direction does not point to the predetermined range, displays the mask character string in the input field.

2. The electronic apparatus according to claim 1, wherein the user interface unit detects a user operation to an operation part for fixing a character string inputted to the input field;
the user authentication unit performs the user authentication on the basis of the character string inputted to the input field and the preregistered password when the user operation to the operation part is detected; and
repeatedly until the user authentication is succeeded, the user interface unit (a) determines a current sight direction of the user on the basis of a face image of the user taken by the imaging device, (b) determines whether or not the current sight direction points to the predetermined range, and (c) if the current sight direction points to the predetermined range, displays the inputted character string in the input field or if the current sight direction does not point to the predetermined range, displays the mask character string in the input field.

3. The electronic apparatus according to claim 1, wherein the predetermined range is either the input field or an operation screen that includes the input field.

4. The electronic apparatus according to claim 1, wherein the user interface unit (a) determines as a reference direction a sight direction of the user on the basis of a face image of the user taken by the imaging device when a key operation occurs to a predetermined key as a reference point and associates the reference point and the reference direction with each other, and (b) determines whether the sight direction points to the predetermined range or not on the basis of the reference point and the reference direction.
